(19) United States
(12) Patent Application Publication
(10) Pub. No.: US 2026/0061871 A1
(43) Pub. Date: Mar. 5, 2026

(54) MOTIVE POWER CHARGER WITH STORED ENERGY SYSTEMS AND METHODS

(71) Applicant: Enatel, Christchurch (NZ)

(72) Inventors: Anton Clark, Christchurch (NZ); Richard Jenman, Christchurch (NZ)

(21) Appl. No.: 19/104,610

(22) PCT Filed: Aug. 21, 2023
(86) PCT No.: PCT/IB2023/058332

§ 371 Date: Feb. 18, 2025

Related U.S. Application Data
(60) Provisional application No. 63/399,415, filed on Aug. 19, 2022.

(51) Int. Cl. B60L 53/53; B60L 53/10; B60L 53/16; B60L 53/31; H02J 7/02; H02J 7/34

(52) U.S. Cl. CPC B60L 53/53; B60L 53/11; B60L 53/16; B60L 53/31; H02J 7/02; H02J 7/342; B60L 2210/30; B60L 2210/40; H02J 2105/37; H02J 2207/20

(57) ABSTRACT

An apparatus includes a storage battery configured to be charged from an alternating current (AC) supply and an AC to direct current (DC) converter to convert the AC supply from AC to DC, such that DC power is output to the storage battery. The apparatus further includes a connector for connecting to a motive power battery. While the motive power battery is connected to the connector, the apparatus is configured to supply DC power to the motive power battery from at least one of the storage battery or the AC to DC converter to charge the motive power battery. While the motive power battery is not connected to the connector, the apparatus is configured to supply DC power to the storage battery to charge the storage battery.

### CROSS REFERENCE TO RELATED APPLICATION

This application claims the benefit of U.S. Provisional Ser. No. 63/399,415, filed Aug. 19, 2022, the entire contents of which are hereby incorporated by reference in their entirety.

### FIELD OF THE DISCLOSURE

The present disclosure generally relates to storing energy using batteries and more particularly to charging a battery using energy stored in another battery.

### BACKGROUND

A battery charging system including a plurality of battery chargers, each configured to charge one or more types of batteries, may be deployed at a single site. The site may be one at which a plurality of chargeable batteries are used, or one from which a plurality of battery-powered devices, such as electric vehicles, are deployed. The site may receive electrical power from a utility provider.

### BRIEF DESCRIPTION OF THE DRAWINGS

FIG. 1 is a diagrammatic view of an example physical structure for charging and storing electrical energy in a battery, in embodiments.

FIG. 2 is a diagrammatic view of an example motive power charger with stored energy, in embodiments.

FIG. 3 is a diagrammatic view of the example motive power charger of FIG. 2 where the storage battery is charging, in embodiments.

FIG. 4 is a diagrammatic view of the example motive power charger of FIG. 2 where the storage battery is discharging and a motive battery is charging, in embodiments.

FIG. 5 a diagrammatic view of another example motive power charger with stored energy, in embodiments.

FIG. 6 is a diagrammatic view of the example motive power charger of FIG. 5 where the storage battery is charging, in embodiments.

FIG. 7 is a diagrammatic view of the example motive power charger of FIG. 5 where the storage battery is discharging and a motive battery is charging, in embodiments.

FIG. 8 is a diagrammatic view of the example motive power charger of FIG. 5 where the motive battery is charging using alternating current (AC) supply only, in embodiments.

FIG. 9 is a diagrammatic view of the example motive power charger of FIG. 5 where the motive battery is charging using energy storage only, in embodiments.

FIG. 10 is a diagrammatic view of an example of a computing environment, in embodiments.

### DETAILED DESCRIPTION

The following disclosure of example methods and apparatuses are not intended to limit the scope of the detailed description to the precise form or forms detailed herein. Instead the following disclosure is intended to be illustrative so that others may follow its teachings.

At certain sites, a large number of batteries may be used, for example, as a source of power for motive power equipment, including electric vehicles (EVs) such as forklifts. Such sites may include warehouses, department stores, manufacturing facilities, or any other sites where materials are handled. While forklifts are merely one use of batteries, batteries may be used for other types of EVs and/or may be used for other purposes than EVs. Batteries at such a site may be charged using battery chargers, so that the batteries may be reusable.

Batteries used for EVs may degrade over time, and therefore no longer be useful in EVs for which a certain voltage output or total capacity may be desired. As such, described herein are various methods and systems for using batteries, such as those that may have degraded to a point that they are not usable for their original purpose, to charge other batteries, such as motive power batteries still being used in EVs.

The energy storage and charging systems and methods described herein may therefore use grid power, renewable power source(s) on site, etc. to charge storage batteries, and power from those storage batteries may be used to charge other batteries, such as those used to power EVs. This may be particularly advantageous where certain facilities pay more for grid or AC power at certain times of day. Thus, a storage battery may be charged at anytime when power is cheaper, regardless of whether any motive power battery needs to be charged at that time of day.

Another advantage of the systems and methods described herein is that certain chargers may be installed to retrofit and work with existing battery chargers. For example, facilities may currently have a charger that only charges motive power batteries from AC or grid power. The systems and method herein provide for a way to add on to or retrofit those systems to make them capable of auxiliary energy storage as described herein.

Other situations where a charger operator may wish to limit the energy drawn from a utility AC source when charging motive power batteries may include: (i) that the capacity of the AC supply from the utility is limited and/or may be expensive or impractical to upgrade to increase capacity; (ii) a utility company bills a customer at least in part based on peak power a customer draws from a utility AC supply; and/or (iii) a utility company bills more for energy at specific times each day, for specific days of the week, etc. In each of these scenarios, a charger operator may wish limit or otherwise control the AC power used to charge batteries for various reasons and in various ways.

The methods and systems further advantageously provide for chargers that can still operate from power stored in a storage battery when an AC supply is temporarily absent (e.g., during a power outage or interruption).

Specifically, energy storage systems and methods as described herein allow a charger operator to decouple the time at which energy is consumed from the utility AC supply from the time in which energy is put into or charged their motive power batteries (e.g., truck batteries). The chargers described herein may therefore charge a truck battery partially or entirely from the storage battery, then replenish the storage battery while no truck battery is present using the utility AC supply at a slower rate, or at a later time.

The methods and systems described herein further provide for a stored energy battery to be connected to the output side of the charger (e.g., on the output side of an alternating current (AC) to direct current (DC) converter that converts utility AC supply into DC power that is appropriate for charging a battery). Such a configuration may have various advantages, such as (i) simplified control and power electronics for the system, as various embodiments may not use an AC inverter; (ii) installation of a charger and storage battery may be simplified compared to an AC connected system; and (iii) when an AC supply is absent, the stored energy in a storage battery may be used for charging while preventing energy being back-fed into the utility AC supply (e.g., which may eliminate use of an automatic transfer switch and related complications). Further, the systems and methods herein may avoid use of a bidirectional AC to DC converter, which may add further complexity and/or cost to a system. Another advantage of the systems and methods described herein is that different nominal voltages or sizes of storage batteries may be used as the storage batteries, as a DC to DC converter may condition the DC power sent to a motive power battery being charged at an appropriate level, regardless of what type of storage battery is used.

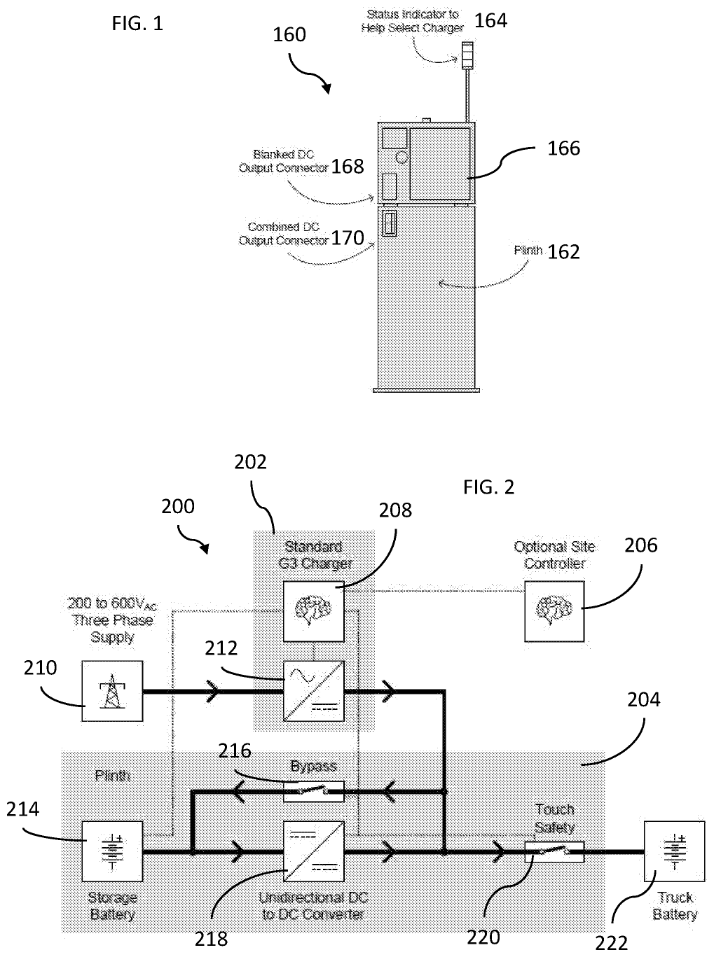

Referring now to the drawings, wherein like numerals refer to the same or similar features in the various views, FIG. 1 is a diagrammatic view of an example physical structure 160 for charging and storing electrical energy in a battery, in embodiments. The example of FIG. 1 specifically shows an example motive power charger with stored energy having a charger 166 and a plinth 162. In various implementations of previous chargers, only a charger 166 may be used, and a DC output connector or connection may provide a place to electically connect or plug in a battery to be charged by the charger 166. The charger 166 may also be elevated off the ground by a pedestal or plinth so that the DC output connector is closer to a battery to be charged (e.g., on or in an EV).

In the example of FIG. 1, the pedestal or plinth is modified to be the plinth 162 that has various electrical components such as energy storage therein. In this way, previous charger systems may be updated or retrofit to accommodate energy storage as described herein. The plinth 162 may have a DC output connector 170 that is used instead of a blanked out slot for a DC output connector 168 of the charger 166. That is, since an output of the charger 166 is routed through components in the plinth 162, the DC output connector 168 of the charger 166 may not longer be used, and the DC output connector 170 may instead be used to plug into or otherwise electrically connect to a motive power battery to be charged. The charger 166 may further include a status indicator 164. The status indicator 164 may indicate that the charger 166 is available for charging a motive power battery, already charging a motive power battery, and/or may indicate a degree to which a storage battery (e.g., in the plinth 162) is charged so that it can be discharged while charging a motive power battery.

Other physical embodiments than the example of FIG. 1 may also be used in various embodiments. For example, certain physical constructions of the components described herein may be configured for mobile and/or outdoor use (e.g., may be in weather protected housings, may be on wheels or otherwise be mobile or easy to move/transport/lift). The plinth may also have a cord and plug or other mechanism for connecting to an AC power supply (either via a connector/plug and/or a hard-wired connection or hard-wired connection with a shut-off switch). In various embodiments, a system may be charged in one location using an AC supply, transported to a location without an AC supply, and used to charge a motive power battery at that location. In various embodiments, that second location may have a lower AC supply that would take a long time to charge a battery, so the systems and methods herein may provide advantages, as the storage battery may charge while a motive power battery is in use, and then both the storage battery and the low AC power may be used to charge the motive power battery (e.g., which may be faster charging than just using the lower AC power alone to charge the motive power battery).

FIG. 2 is a diagrammatic view of an example motive power charger 200 with stored energy, in embodiments. The charger 200 may include a charger 202 with an AC to DC converter 212 having an output suitable to charge various batteries (e.g., storage batter 214, truck battery 222 (an example of a motive power battery)) and a controller 208, which may be used to control and/or communicate with any of the AC to DC converter 212, a DC to DC converter 218 in a plinth 204, a bypass switch 216, a touch safety switch 220, and/or a storage battery 214, or sensors or other devices associated with any of the foregoing. The controller 208 may also communicate with an optional site controller 206 (e.g., over Ethernet, over Wi-Fi) and a truck battery 222 (e.g., over a controller area network (CAN) bus, over a power line carrier (PLC)). The controller 208 may also be configured to detect a presence of the truck battery 222 based on, for example, a presence of voltage at the motive power charger 200's output (e.g., at a connector associated with the touch safety switch 220 where the truck battery electrically connects to the motive power charger 200), from a pilot signal, and/or from the presence of PLC or CAN bus messages from the battery. In FIGS. 2-9, the solid connectors may represent electrical power wiring and/or connections, while the dotted lines may represent control wiring and/or connections between components.

The plinth 204 may be a housing, such as that shown in FIG. 1, that contains the storage battery 214, the DC to DC converter 218, the bypass switch 216, and the touch safety switch 220. As shown in FIG. 1, the plinth 204 may be a same width as the charger 202 (e.g., 311 mm), and could have a same or varying depth as that charger 202.

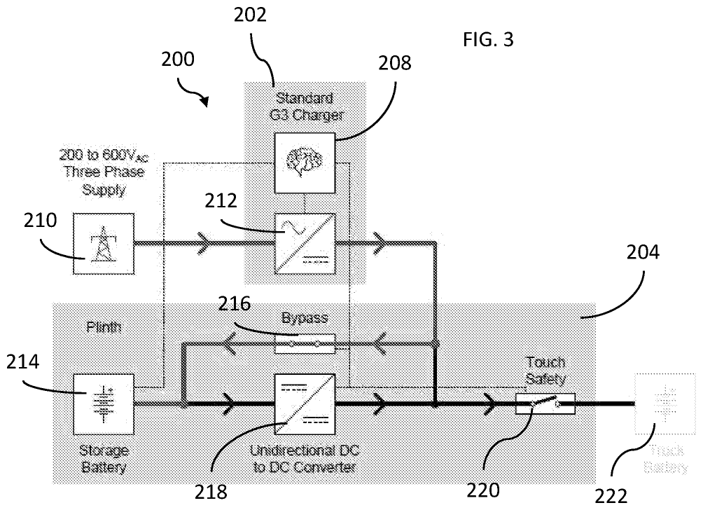

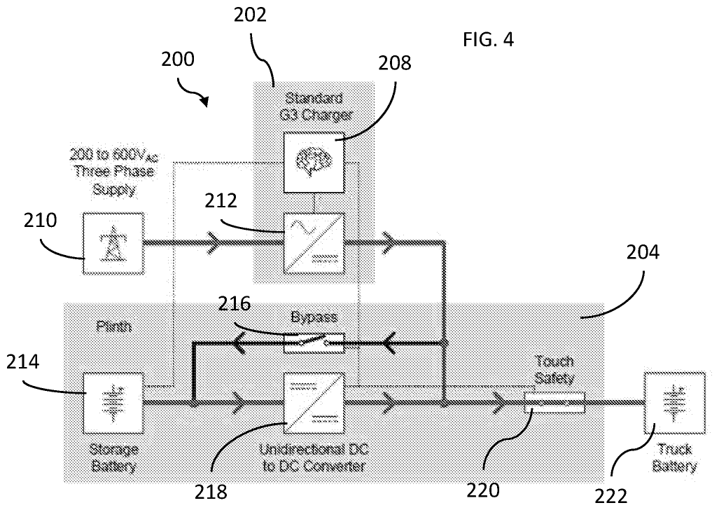

The bypass switch 216 may connects the storage battery 214 directly to charger 202 output (e.g., the output of the AC to DC converter 212) while the storage battery 214 is charging (e.g., when no truck battery 222 is present), such as emphasized in FIG. 3 where the bypass switch 216 is closed and the touch safety switch 220 is open. FIG. 4 is a shows the bypass switch 216 being open and the touch safety switch 220 being closed while the storage battery 214 is discharging and the truck battery 222 is charging.

The touch safety switch 220 may be used to ensure that a non-touch safe DC output connector (not shown in FIG. 2, but is between the touch safety switch 220 and the truck battery 222) is not live while the storage battery 214 is charging. The touch safety switch 220 may also prevent the truck and storage batteries from becoming directly connected if a truck battery is connected while the storage battery is being charged. In various embodiments, the bypass and touch safety switches may be interlocked so that only one may be closed at any given time. For example, this could be one form C switch. In various examples, interlocked switches may be implemented with either logic of the controller 208 and/or through mechanical interlocks that prevent both switches from being on at the same time.

The DC to DC convertor 218 is configured to step up or down the storage battery 214 supply to a desired current and voltage specified by the controller 208 (e.g., to match the truck battery 222 and/or AC to DC converter 212 output specifications). In this way, the power output to the truck battery 222 may suit both the truck battery 222 and any type of the storage battery 214 that may be used. The DC to DC convertor 218 output range may, for example, match the output range of the charger 202 (e.g., 4 to 136 Volts DC (VDC)).

The storage battery 214 may be different batteries in different embodiments. For example, the storage battery 214 may be a complete motive power type battery pack, such as a lithium ion battery with a nominal voltage from 24 to 96V. The storage battery 214 may be a group of battery modules taken from a motive power battery pack, such as lithium ion with a nominal voltage from 24 to 40V. In such an embodiment, more than one such module may be used in a series and/or parallel arrangement. The storage battery 214 may also be a set of one or more rack mount lithium ion battery modules, for example having a 50 VDC output. As such, for motive power type batteries or battery components, use of those batteries as the storage battery 214 may be a second or third life application, where they had previously been used to power a battery electric industrial truck (e.g., as a motive power battery or as the truck battery 222).

The truck battery 222 may be, for example, any lithium ion or lead acid battery that may be charged by the charger 202 (e.g., a G3 charger). Such batteries may be used to power electric battery industrial trucks (e.g., forklifts).

A site controller 206 may also be used. For example, if a motive power charger 200 is used as a standalone charger, the motive power charger 200 may determines which energy sources to use (e.g., AC supply, storage battery, or both) independently. Such a decision may be made by the controller 208, and may, for example, be based on a limit placed on the power it will draw from an AC supply, above which power will be drawn from the storage battery.

With the site controller 206, multiple motive power chargers 200 may be used and controlled together to accomplish various site power goals (e.g., maximum AC supply draw). For example, the site controller 206 may receive status information from a number of the motive power chargers 200 at a site and the site controller 206 may make decisions on how each motive power charger 200 uses its energy sources (e.g., how and when it uses AC supply, the storage battery, or both).

For example, if a first motive power charger has a depleted storage battery, the site controller 206 could cause that first motive power charger to draw more from the AC supply, while a second motive power charger may be caused to draw more power from its charged storage battery to compensate. In another example, the site controller 206 may direct an EV operator to a system with a more charged storage battery (e.g., output to the indicator 164 or other output which motive power charger to use).

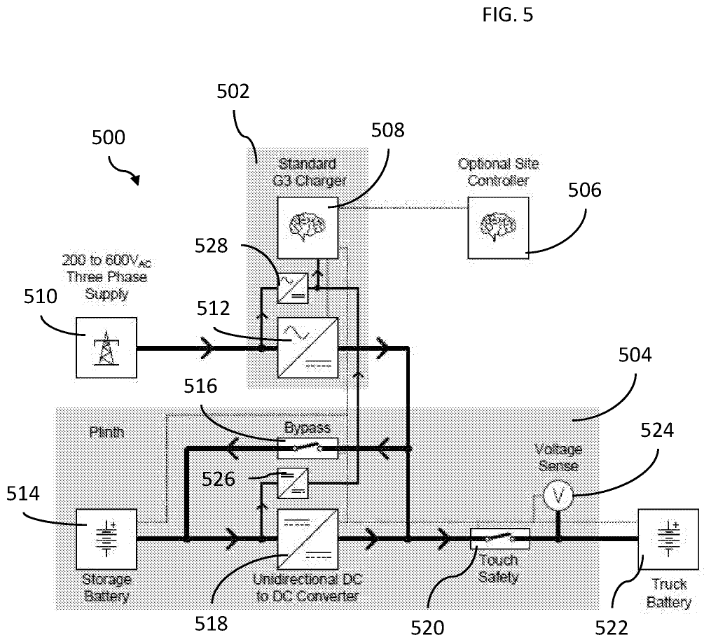

FIG. 5 a diagrammatic view of another example motive power charger 500 with stored energy, in embodiments. The motive power charger 500 may have similar or identical components and functionalities to those shown in and described with respect to FIGS. 1-4, such as a charger 502, a controller 508, an AC to DC converter 512, an AC supply 510, a site controller 506, a plinth 504, a bypass switch 516, a storage battery 514, a DC to DC converter 518, a touch safety 520, and a truck battery 522.

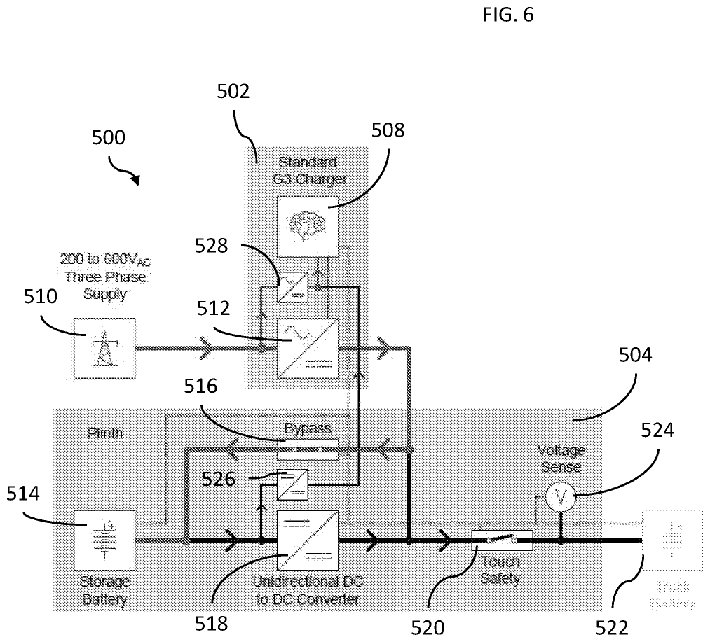

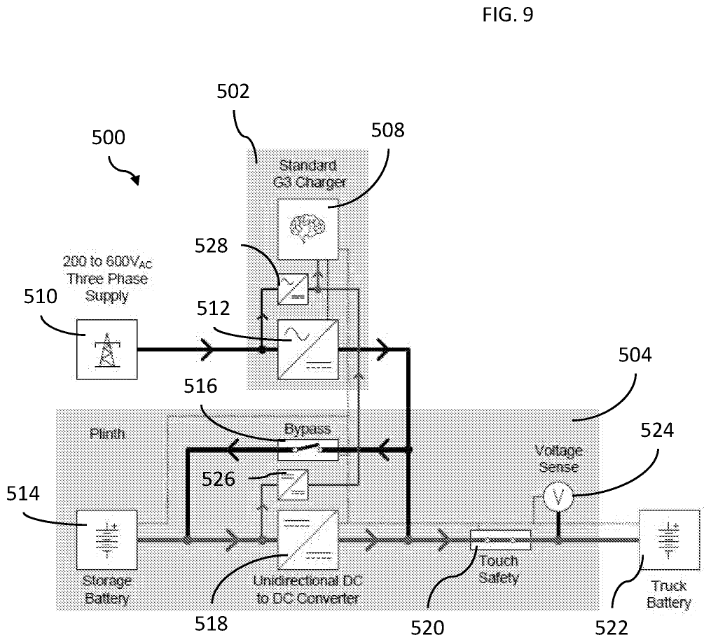

The motive power charger 500 may also have an AC to DC converter 528 that is able to power the controller 508, by converting AC power from the AC supply 510 to DC power for the controller 508, as demonstrated in FIGS. 6-8. The motive power charger 500 may also have an auxiliary DC to DC converter 526 that may power the controller 508 when the AC supply 510 to the system is absent or otherwise not being used, as shown in FIG. 9. The motive power charger 500 also shows a voltage sensor 524 configured to sense that the truck battery 522 is connected or not. When the sensor 524 senses the presence of the truck battery 522, the touch safety switch 520 may be controlled to close and the bypass switch 516 may be controlled to be open. When the sensor 524 senses the absence of the truck battery 522, the touch safety switch 520 may be controlled to open and the bypass switch 516 may be controlled to be close. Such switching may automatically cause the truck battery 522 to be charged from the storage battery 514 and/or the AC supply 510 upon connection of the truck battery 522 to the motive power charger 500, and/or for the AC supply 510 to automatically start charging the storage battery 514 when the truck battery 522 is not connected.

FIG. 6 is a diagrammatic view of the example motive power charger of FIG. 5 where the storage battery is charging, in embodiments. In this mode (e.g., similar to FIG. 3 above), the truck battery 522 is not present. The charger 508 draws energy from the utility AC supply 510 and transforms it into a DC supply suitable for the storage battery 514. The bypass switch 516 bypasses the DC to DC converter 518, connecting the charger 502′s output directly to the storage battery 514.

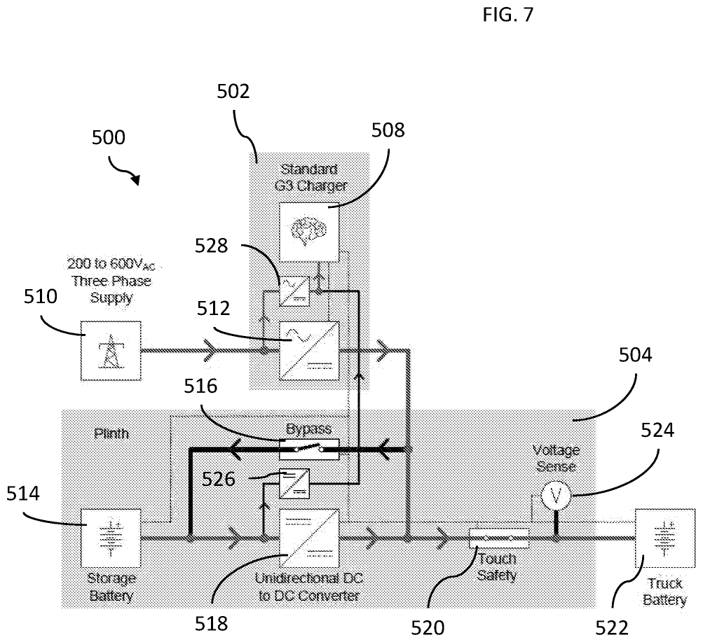

FIG. 7 is a diagrammatic view of the example motive power charger of FIG. 5 where the storage battery is discharging and a motive battery is charging, in embodiments. In this mode (e.g., similar to FIG. 4 above), the truck battery 522 is present. The truck battery 522 is charged from the utility AC source 510 (through the charger 502) and/or the storage battery 514 (through the DC to DC converter 518). The bypass switch 516 is open and the touch safety switch 520 is closed.

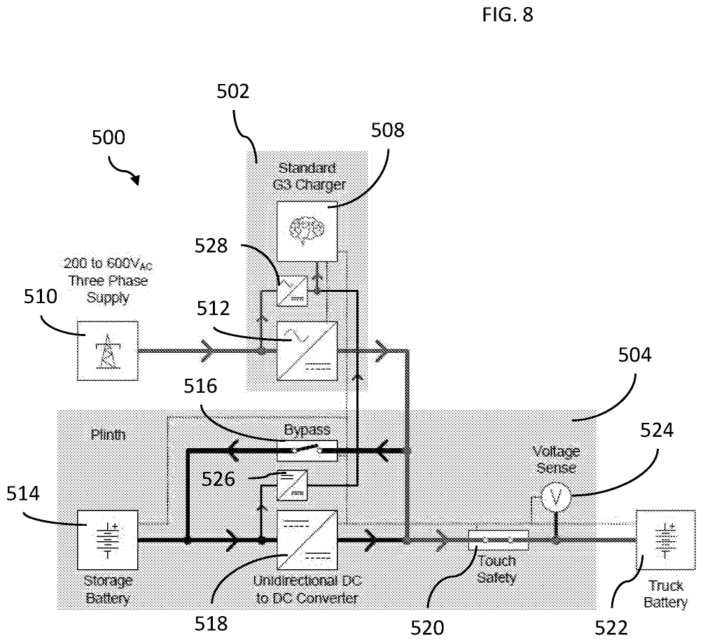

The motive power charger 500 may also charge the truck battery 522 using either the utility AC source only as shown in FIG. 8, the storage battery only as shown in FIG. 9, or both sources in parallel as shown in FIG. 7. Note that in the embodiment of FIG. 9, the controller 508 is supplied by energy from the storage battery 514. This may allow the motive power charger 500 to continue operating even if the AC supply 510 is temporarily absent or otherwise unavailable or shut off.

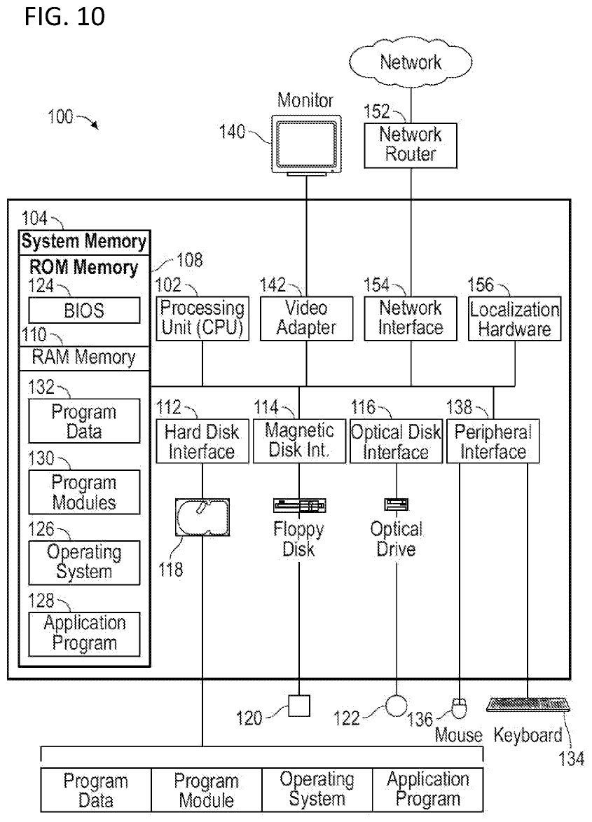

FIG. 10, further described below, describes a computing device and/or environment that may be used as a controller, such as a charger controller, site controller, or may communicate with any of the controllers described herein. In various embodiments, only some of the components described below with respect to FIG. 10 may be used as a controller or computing device. In various embodiments, the motive power chargers described herein may therefore include various components and/or aspects of FIG. 10, or may communicate with computing devices similar to FIG. 10 or otherwise having components or aspects similar to that of FIG. 10.

FIG. 10 is a diagrammatic view of an example of a computing environment that includes a general-purpose computing system environment 100, such as a desktop computer, laptop, smartphone, tablet, or any other such device having the ability to execute instructions, such as those stored within a non-transient, computer-readable medium. Various computing devices as disclosed herein (e.g., the controller 174, a demand response module (DRM), or any other computing device in communication with the control 174) may be similar to the computing system 100 or may include some components of the computing system 100. Furthermore, while described and illustrated in the context of a single computing system 100, those skilled in the art will also appreciate that the various tasks described hereinafter may be practiced in a distributed environment having multiple computing systems 100 linked via a local or wide-area network in which the executable instructions may be associated with and/or executed by one or more of multiple computing systems 100.

In its most basic configuration, computing system environment 100 typically includes at least one processing unit 102 and at least one memory 104, which may be linked via a bus 106. Depending on the exact configuration and type of computing system environment, memory 104 may be volatile (such as RAM 110), non-volatile (such as ROM 108, flash memory, etc.) or some combination of the two. Computing system environment 100 may have additional features and/or functionality. For example, computing system environment 100 may also include additional storage (removable and/or non-removable) including, but not limited to, magnetic or optical disks, tape drives and/or flash drives. Such additional memory devices may be made accessible to the computing system environment 100 by means of, for example, a hard disk drive interface 112, a magnetic disk drive interface 114, and/or an optical disk drive interface 116. As will be understood, these devices, which would be linked to the system bus 306, respectively, allow for reading from and writing to a hard disk 118, reading from or writing to a removable magnetic disk 120, and/or for reading from or writing to a removable optical disk 122, such as a CD/DVD ROM or other optical media. The drive interfaces and their associated computer-readable media allow for the nonvolatile storage of computer readable instructions, data structures, program modules and other data for the computing system environment 100. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 100.

A number of program modules may be stored in one or more of the memory/media devices. For example, a basic input/output system (BIOS) 124, containing the basic routines that help to transfer information between elements within the computing system environment 100, such as during start-up, may be stored in ROM 108. Similarly, RAM 110, hard drive 118, and/or peripheral memory devices may be used to store computer executable instructions comprising an operating system 126, one or more applications programs 128 (which may include the functionality disclosed herein, for example), other program modules 130, and/or program data 122. Still further, computer-executable instructions may be downloaded to the computing environment 100 as needed, for example, via a network connection.

An end-user may enter commands and information into the computing system environment 100 through input devices such as a keyboard 134 and/or a pointing device 136. While not illustrated, other input devices may include a microphone, a joystick, a game pad, a scanner, etc. These and other input devices would typically be connected to the processing unit 102 by means of a peripheral interface 138 which, in turn, would be coupled to bus 106. Input devices may be directly or indirectly connected to processor 102 via interfaces such as, for example, a parallel port, game port, firewire, or a universal serial bus (USB). To view information from the computing system environment 100, a monitor 140 or other type of display device may also be connected to bus 106 via an interface, such as via video adapter 132. In addition to the monitor 140, the computing system environment 100 may also include other peripheral output devices, not shown, such as speakers and printers.

The computing system environment 100 may also utilize logical connections to one or more computing system environments. Communications between the computing system environment 100 and the remote computing system environment may be exchanged via a further processing device, such a network router 152, that is responsible for network routing. Communications with the network router 152 may be performed via a network interface component 154. Thus, within such a networked environment, e.g., the Internet, World Wide Web, LAN, or other like type of wired or wireless network, it will be appreciated that program modules depicted relative to the computing system environment 100, or portions thereof, may be stored in the memory storage device(s) of the computing system environment 100.

The computing system environment 100 may also include localization hardware 186 for determining a location of the computing system environment 100. In some instances, the localization hardware 156 may include, for example only, a GPS antenna, an RFID chip or reader, a WiFi antenna, or other computing hardware that may be used to capture or transmit signals that may be used to determine the location of the computing system environment 100.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments.

It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents.

What is claimed is:

1. An apparatus comprising:
a storage battery configured to be charged from an alternating current (AC) supply;
an AC to direct current (DC) converter to convert the AC supply from AC to DC, such that DC power is output to the storage battery; and
a connector for connecting to a motive power battery;
wherein:
while the motive power battery is connected to the connector, the apparatus is configured to supply DC power to the motive power battery from at least one of the storage battery or the AC to DC converter to charge the motive power battery; and
while the motive power battery is not connected to the connector, the apparatus is configured to supply DC power to the storage battery to charge the storage battery.

2. The apparatus of claim 1, further comprising a DC to DC converter electrically connected between the storage battery and the connector.

3. The apparatus of claim 1, further comprising a first switch in a first electrical path between the storage battery and the connector and a second switch in a second electrical path between the AC to DC converter and the storage battery.

4. The apparatus of claim 3, wherein while the apparatus is configured to supply DC power to the motive power battery, the first switch is closed and the second switch is open.

5. The apparatus of claim 3, wherein while the apparatus is configured to supply DC power to the storage battery, the first switch is open and the second switch is closed.

6. The apparatus of claim 3, wherein the first switch comprises a touch safety switch that is open whenever the motive storage battery is not connected to the connector.

7. The apparatus of claim 3, wherein the first switch and the second switch are interlocked logically or mechanically, such that only one of the first switch or the second switch are open at any one time.

8. The apparatus of claim 1, wherein the storage battery is enclosed within a plinth.

9. The apparatus of claim 8, wherein the connector is exposed on an exterior of the plinth to provide a connection point for the motive power battery.

10. The apparatus of claim 1, further comprising a controller configured to control the AC to DC converter.

11. The apparatus of claim 10, further comprising an electrical connection between the AC supply and the controller, wherein the AC supply is configured to provide power to the controller.

12. The apparatus of claim 11, wherein the electrical connection comprises a second AC to DC converter, such that DC power is output to the controller.

13. The apparatus of claim 10, further comprising an electrical connection between the storage battery and the controller, wherein the storage battery is configured to provide power to the controller.

14. The apparatus of claim 13, wherein the electrical connection comprises a DC to DC converter, such that DC power from the storage battery is modified before supplying the DC power to the controller.

15. The apparatus of claim 1, further comprising a voltage sensor configured to sense a presence of the motive power battery connected to the connector.

16. The apparatus of claim 15, further comprising a controller configured to, while the voltage sensor senses that the motive power battery is connected to the connector, close a first switch in a first electrical path between the storage battery and the connector and open a second switch in a second electrical path between the AC to DC converter and the storage battery.

17. The apparatus of claim 16, where in the controller is further configured to, while the voltage sensor senses that the motive power battery is not connected to the connector, open the first switch and close the second switch.
